(19) United States
(12) Patent Application Publication
(10) Pub. No.: US 2025/0296460 A1
(43) Pub. Date: Sep. 25, 2025

(54) VEHICLE SYSTEMS AND USER-CONFIGURABLE CHARGING METHODS

(71) Applicant: GM GLOBAL TECHNOLOGY OPERATIONS LLC, Detroit, MI (US)

(72) Inventors: Omar Ashraf, Auburn Hills, MI (US); Philip James Prociw, Clinton Township, MI (US); Jenna Hansen, Sterling Heights, MI (US); Justin Anthony Bunnell, Farmington Hills, MI (US)

(73) Assignee: GM GLOBAL TECHNOLOGY OPERATIONS LLC, Detroit, MI (US)

(21) Appl. No.: 18/612,811

(22) Filed: Mar. 21, 2024

(51) Int. Cl. B60L 53/30; B60L 53/62; B60L 58/26; H02J 7/00

(52) U.S. Cl. CPC B60L 53/305; B60L 53/62; B60L 58/26; H02J 7/007194; B60L 2240/80; B60L 2250/12; B60L 2250/16

(57) ABSTRACT

Vehicles and related systems and methods are provided for user-configurable charging of an energy source associated with a vehicle. One method involves receiving user input indicative of a selected charging mode, determining an expected duration of time for a charging event associated with the selected charging mode, receiving a current temperature indicator from a temperature sensor associated with the vehicle, determining a current temperature associated with the energy source based on the current temperature indicator, determining a temperature control charging current for the charging event based at least in part on the current temperature and the expected duration of time for the charging event, and transmitting a current request for the temperature control charging current to an external charging system.

### INTRODUCTION

The technical field generally relates to vehicle systems and more particularly relates to vehicle electrical systems and related charging methods for rechargeable energy storage systems.

Advances in technology have led to substantial changes in the design of automotive vehicles. In particular, electric motors (or electric machines) are finding an increasing number of applications in the automotive industry due to the electrification of the automotive drive system. Electric and/or hybrid vehicles utilize electric motors as either primary or supplemental torque sources in the automotive drive system. In electric and/or hybrid vehicles, the electric motor is typically powered by a rechargeable energy source, such as a battery, using one or more power conversion modules to produce the desired alternating current electrical signals across the stator windings of the electric motor.

Electric vehicles, such as fully electric vehicles, battery electric vehicles (BEVs), and hybrid electric vehicles including plug-in hybrid electric vehicles (PHEVs), include high voltage (HV) battery packs. The HV battery packs typically provide power to HV direct current (DC) loads and to one or more auxiliary power modules that convert a high voltage to a lower voltage to support lower voltage loads. The HV battery packs are periodically recharged to allow for continued operation of the vehicle, and accordingly, it is desirable to recharge the HV battery pack in a manner that reduces downtime and improves user experience.

### SUMMARY

Apparatus for a vehicle and related methods and vehicle systems are provided. In an exemplary implementation, a method of charging an energy source in a vehicle coupled to an external charging system involves receiving, by a control module associated with the vehicle, a first user input indicative of a selected charging mode from among a plurality of charging modes, determining, by the control module, an expected duration of time for a charging event associated with the selected charging mode, receiving, by the control module, a current temperature indicator from a temperature sensor associated with the vehicle, determining, by the control module, a current temperature associated with the energy source based on the current temperature indicator, determining, by the control module, a temperature control charging current for the charging event based at least in part on the current temperature and the expected duration of time for the charging event, and transmitting, by the control module, a current request for the temperature control charging current to the external charging system.

In one or more implementations, receiving the first user input involves transmitting, by the control module, a display request for a charging mode selection graphical user interface (GUI) to be displayed on a user interface device associated with the vehicle, wherein the charging mode selection GUI includes a plurality of GUI elements for receiving the first user input indicative of the selected charging mode, and determining, by the control module, the selected charging mode in response to manipulation of a respective GUI element of the plurality of GUI elements associated with the selected charging mode. In a further implementation, the charging mode selection GUI includes a first GUI element for receiving a second user input indicative of a user's expectation of a duration of time for the charging event and determining the expected duration of time for the charging event is further based on the second user input. In another implementation, providing the charging mode selection GUI involves automatically providing the charging mode selection GUI in response to detecting a connection between a charging port of the vehicle and the external charging system. In another implementation, the method involves receiving, by the control module, a vehicle park indicator indicating that a transmission of the vehicle has been placed into park; and wherein the control module transmits the display request in response to receiving the vehicle park indicator.

In one or more implementations, the expected duration of time corresponds to charging the energy source above a targeted state of charge. In a further implementation, the method involves determining an initial state of charge of the energy source prior to the charging event, wherein determining the expected duration of time for charging the energy source above the targeted state of charge involves calculating the expected duration of time based on a relationship between the initial state of charge and the targeted state of charge.

In some implementations, the method involves determining a temperature limit associated with the energy source based at least in part on a current operating context, wherein determining the temperature control charging current involves determining the temperature control charging current for the charging event based at least in part on a difference between the temperature limit and the current temperature. In one implementation, the method involves determining a cooling capability of the vehicle based at least in part on the current operating context, wherein determining the temperature control charging current involves determining the temperature control charging current for the charging event based at least in part on the cooling capability. In one or more implementations, determining the temperature control charging current involves calculating a value for the temperature control charging current in accordance with the equation

$${I}_{t} = \sqrt{( \frac{1}{R} ( \frac{m * c * Δ T}{Δ t} + {q}_{c} ) )} ,$$

wherein Iₜ represents the temperature control charging current, Δt represents the expected duration of time for the charging event, q_{c} represents the cooling capability of the vehicle, ΔT represents the difference between the temperature limit and the current temperature, m represents a mass of the energy source, c represents a specific heat of the energy source, and R represents a resistance of the energy source.

In one or more implementations, determining the temperature control charging current involves calculating a value for the temperature control charging current in accordance with the equation

$${I}_{t} = \sqrt{( \frac{1}{R} ( \frac{m * c * Δ T}{Δ t} + {q}_{c} ) )} ,$$

wherein Iₜ represents the temperature control charging current, Δt represents the expected duration of time for the charging event, q_{c} represents a cooling capability of the vehicle, ΔT represents a difference between a temperature limit and the current temperature, m represents a mass of the energy source, c represents a specific heat of the energy source, and R represents a resistance of the energy source.

An apparatus for a non-transitory computer-readable medium is also provided. The computer-readable medium has stored thereon executable instructions that, when executed by a processor, cause the processor to provide a charging management service configurable to receive user input indicative of a selected charging mode from among a plurality of charging modes for an energy source of a vehicle, determine an expected duration of time for a charging event associated with the selected charging mode, receive a current temperature indicator from a temperature sensor associated with the vehicle, determine a current temperature associated with the energy source based on the current temperature indicator, determine a temperature control charging current for the charging event based at least in part on the current temperature and the expected duration of time for the charging event, and transmit a current request for the temperature control charging current to an external charging system.

In one or more implementations, the charging management service is configurable to provide a charging mode selection graphical user interface (GUI) on a user interface device associated with the vehicle, wherein the charging mode selection GUI includes a plurality of GUI elements for receiving the user input indicative of the selected charging mode, and identify the selected charging mode in response to manipulation of a respective GUI element of the plurality of GUI elements associated with the selected charging mode. In one implementation, the charging mode selection GUI includes a first GUI element for receiving a second user input indicative of the expected duration of time, and the charging management service is configurable to identify the expected duration of time based on the second user input.

In one or more implementations, the charging management service is configurable to identify the expected duration of time based at least in part on a targeted state of charge.

In one or more implementations, the charging management service is configurable to determine a temperature limit associated with the energy source based at least in part on a current operating context, wherein determining the temperature control charging current involves determining the temperature control charging current for the charging event based at least in part on a difference between the temperature limit and the current temperature. In one implementation, the charging management service is configurable to calculate a value for the temperature control charging current in accordance with the equation

$${I}_{t} = \sqrt{( \frac{1}{R} ( \frac{m * c * Δ T}{Δ t} + {q}_{c} ) )} ,$$

wherein Iₜ represents the temperature control charging current, Δt represents the expected duration of time for the charging event, q_{c} represents a cooling capability of the vehicle, ΔT represents the difference between the temperature limit and the current temperature, m represents a mass of the energy source, c represents a specific heat of the energy source, and R represents a resistance of the energy source.

A vehicle system is also provided that includes an electric motor, an energy source, a temperature sensor to provide an indication of a current temperature of the energy source, a power conversion module coupled between the energy source and the electric motor, a charging port coupled to the energy source, a user interface device, and a control module coupled to the energy source, the charging port and the user interface device to provide a charging management service. The charging management service is configurable to provide a charging mode selection graphical user interface (GUI) on the user interface device, wherein the charging mode selection GUI includes a plurality of GUI elements for receiving a user input indicative of a selected charging mode, determine an expected duration of time for a charging event associated with the selected charging mode, determine a temperature control charging current for the charging event based at least in part on the expected duration of time for the charging event and the indication of the current temperature of the energy source, and transmit a current request for the temperature control charging current to an external charging system coupled to the charging port. In one implementation, the expected duration of time is influenced by a targeted state of charge for the energy source and the energy source comprises at least one of a rechargeable energy storage system (RESS) and a rechargeable high voltage battery pack. In another implementation, the charging management service is configurable to automatically provide the charging mode selection GUI on the user interface device in response to detecting a connection between the charging port and the external charging system.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating an electrical system suitable for use with a vehicle that is configurable to support a charging management service that detects a loss of isolation on an alternating current (AC) side of the electrical system in accordance with various implementations;

FIG. 2 is a block diagram of an exemplary charging system including a vehicle integration control module suitable for use in the electrical system of FIG. 1;

FIG. 3 is a flow diagram illustrating an exemplary user-configurable charging process suitable for implementation by a charging management service in the vehicle electrical system of FIG. 1 or the charging system of FIG. 2 according to one or more implementations described herein; and

FIG. 4 is a flow diagram illustrating an exemplary temperature control charging current determination process suitable for implementation in connection with the user-configurable charging process of FIG. 3 according to one or more implementations described herein.

### DETAILED DESCRIPTION

The following detailed description is merely exemplary in nature and is not intended to limit the application and uses. Furthermore, there is no intention to be bound by any expressed or implied theory presented in the preceding introduction, summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components and/or any suitable combinations thereof that provide the described functionality.

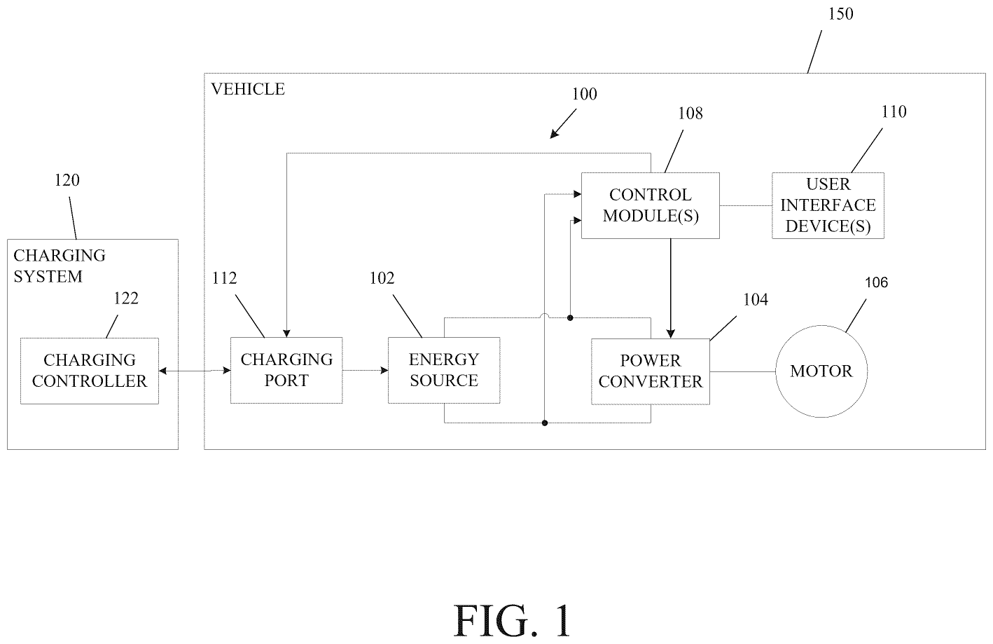

FIG. 1 depicts an exemplary implementation of an electrical system 100 suitable for use in an automotive vehicle 150. The illustrated electrical system 100 includes, without limitation, an energy source 102, a power conversion module 104, an electric motor 106, a control system 108, and one or more user interface devices 110. In the illustrated implementation, the control system 108 is coupled to the power conversion module 104 and generates commands for operating the power conversion module 104 in a manner that results in the desired operation of the electric motor 106 in response to commands received from the driver of the vehicle 150 (e.g., via an accelerator pedal, brake pedal, cruise control system, collision avoidance system, etc.). The energy source 102 is coupled to a charging port 112, which generally represents the combination of electrical terminals, pins or other interfaces, electrical cables or wiring, and switching elements capable of being arranged electrically in series between the energy source 102 and an external charging system 120 to facilitate charging (or recharging) the energy source 102 via the charging port 112. As described in greater detail below, in exemplary implementations, a charging management service at the control system 108 receives or otherwise obtains user input indicative of a desired mode or configuration for charging the energy source 102 and provides corresponding commands to the charging system 120 via the charging port 112 to support charging (or recharging) the energy source 102 in a user-configurable manner.

The energy source 102 (or power source) generally represents the component in the vehicle 150 that is capable of providing a direct current (DC) voltage to the power conversion module 104 for operating the electric motor 106. In exemplary implementations, the energy source 102 is realized as a rechargeable high voltage battery pack or battery; however, it should be appreciated that the subject matter described herein is not necessarily limited to batteries, and in practice, the energy source 102 may include or otherwise be realized as one or more fuel cells, ultracapacitors, DC-to-DC converters, rectifiers, voltage regulators, or another suitable energy source known in the art. That said, in exemplary implementations, the subject matter is described herein in the context of the energy source 102 being realized as a rechargeable energy storage system (RESS) including one or more rechargeable batteries configured to provide the desired DC voltage for operating the electric motor 106.

The power conversion module 104 generally represents the component in the vehicle 150 that is coupled between the energy source 102 and the electric motor 106 to convert the DC power from the energy source 102 into alternating current (AC) power for driving the electric motor 106. In this regard, in exemplary implementations, the power conversion module 104 is realized as a power inverter having one or more phase legs, with each phase leg corresponding to a respective phase of the electric motor 106. Generally, switches of a phase leg are modulated (opened or closed) at a particular switching frequency and duty cycle to produce an AC voltage across its associated phase of stator windings of the electric motor 106, which, in turn, creates torque-producing current in those stator windings and operates the electric motor 106. For purposes of explanation, but without limitation, the power conversion module 104 may alternatively be referred to herein as an inverter module or a power inverter; however, the subject matter described herein is not necessarily limited to DC-to-AC power converters.

In one exemplary implementation, the electric motor 106 is realized as an induction motor, however, the subject matter described herein should not be construed as being limited to use with any particular type of electric motor. In other implementations, the electric motor 106 may be realized as an internal permanent magnet (IPM) motor, a synchronous reluctance motor, or another suitable motor known in the art. Although not illustrated in FIG. 1, the motor 106 may include a transmission integrated therein such that the motor 106 and the transmission are mechanically coupled to at least some of the wheels of the vehicle 150 through one or more drive shafts, so that the speed of the motor 106 (e.g., the rotational velocity of the rotor) influences the speed of the vehicle 150.

In exemplary implementations, the vehicle 150 is realized as an automobile, and depending on the implementation, the vehicle 150 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). In exemplary implementations, the vehicle 150 is realized as a fully electric vehicle, a plug-in hybrid vehicle, or the like. However, in various implementations, the vehicle 150 may be realized as a fuel cell vehicle (FCV) or another suitable alternative fuel vehicle, and/or the vehicle 150 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen, natural gas, propane, etc.) fueled engine, and/or a combustion/electric motor hybrid engine. That said, it should be appreciated the subject matter described herein is not limited to automotive vehicles and may be implemented in an equivalent manner in the context of aircraft or aerial vehicles, marine vessels, heavy duty vehicles and/or the like.

In exemplary implementations, the one or more user interface devices 110 generally represent the components associated with the vehicle 150 that are capable of receiving inputs from a driver or other user of the vehicle 150 and providing one or more graphical user interface (GUI) displays or other user notifications or alerts. For example, in some implementations, a user interface device 110 may include or otherwise be realized as an electronic display device that is located onboard the vehicle 150 or otherwise associated with another system onboard the vehicle 150, such as, for example, any sort of infotainment module, navigation head unit, or another similar or suitable unit that resides onboard the vehicle 150, which may be integrated into a dashboard or other console within a passenger compartment of the vehicle 150. In this regard, the user interfaces devices 110 may also include or otherwise incorporate one or more touch pads, touch panels, touch screens, buttons, knobs, levers, joysticks and/or other suitable user input devices that may be integrated into the dashboard or other console within a passenger compartment. That said, in yet other implementations, a user interface device 110 could be realized as an electronic device associated with a vehicle owner or other user associated with the vehicle 150 that is separate and distinct from the vehicle 150 but communicatively coupled to the control system 108 over a communications network, such as, for example, a smartphone, a mobile computer (e.g., a tablet computer, a laptop computer, or a netbook computer), a wearable computing device (e.g., smart watch, smart glasses, smart clothing), or the like.

Still referring to FIG. 1, the control system 108 generally represents the hardware, firmware, software and/or other components of the electrical system 100 that is suitably configured to operate the power conversion module 104 to provide electrical power to the electric motor 106 and support communications with an external charging system 120 to facilitate charging the energy source 102. In practice, the control system 108 may include any number of different control modules that are cooperatively configured to support the subject matter described herein, where depending on the implementation, the control modules can include or be realized as any custom made or commercially available processor, a central processing unit (CPU), a graphics processing unit (GPU), a system on a chip (SoC), a semiconductor-based microprocessor (in the form of a microchip or chip set), any combination thereof, or generally any device for executing instructions. In practice, the control system 108 includes or otherwise supports processing logic that is configurable to carry out the functions, techniques, and processing tasks associated with the operation of the vehicle electrical system 100, as described in greater detail below.

In exemplary implementations, the steps of a method or algorithm described in connection with the implementations disclosed herein may be embodied directly in hardware, in firmware, in a software module executed by the control system 108, or in any practical combination thereof. In exemplary implementations, the control system 108 includes or otherwise accesses a data storage element, memory, or any other short or long term storage media or other suitable non-transitory computer-readable device or media capable of storing programming instructions for execution by the control system 108, which may include volatile and nonvolatile storage in read-only memory (ROM), random-access memory (RAM), keep-alive memory (KAM), flash memory, registers, hard disks, removable disks, magnetic or optical mass storage and/or the like. The computer-executable programming instructions, when read and executed by the control system 108, cause the control system 108 to execute, support, generate or otherwise provide a charging management service that supports user-configurable charging of the energy source 102 and performs various tasks, operations, functions, and processes described herein.

In exemplary implementations, the charging management service provided by the control system 108 is configurable to support interoperability with an external charging system 120 via the charging port 112 to allow a charging current supplied by the external charging system 120 to be provided to the energy source 102 while maintaining the charging current within commanded limits determined by the charging management service, as described in greater detail below. In the illustrated implementation, the external charging system 120 is a so-called smart charger or otherwise supports so-called smart charging and includes a charging controller 122 that generally represents the processors, logic, sensors, and other hardware and/or software configurable to support communications with the control system 108 via the charging port 112 for ensuring the charging current provided by the charging system 120 satisfies the charging requirements of the energy source 102 that are commanded, instructed or otherwise requested by the charging management service at the control system 108. In exemplary implementations, the external charging system 120 is realized as a DC fast charging system (or DC fast charger) capable of providing an output DC voltage at the charging port 112 that results in a requested DC charging current to the energy source 102. That said, in other implementations, the external charging system 120 may be configured to deliver an AC charging current that is converted to a corresponding DC charging current by or at the charging port 112, the energy source 102 or another component of the vehicle electrical system 100 (e.g., a rectifier, AC-to-DC converter, or the like arranged between the charging port 112 and the energy source 102).

It should be appreciated that the communications between the control system 108 and the external charging system 120 and corresponding technical implementation details are not germane to this disclosure, and accordingly, are not described in detail herein. For example, in practice, the charging port 112, the charging system 120 and the control system 108 may be cooperatively configured to support one or more of the Combined Charging System (CCS) standard, the SAE J1772 standard or another suitable standard for communications and power transmission between a vehicle 150 and an external charging system 120.

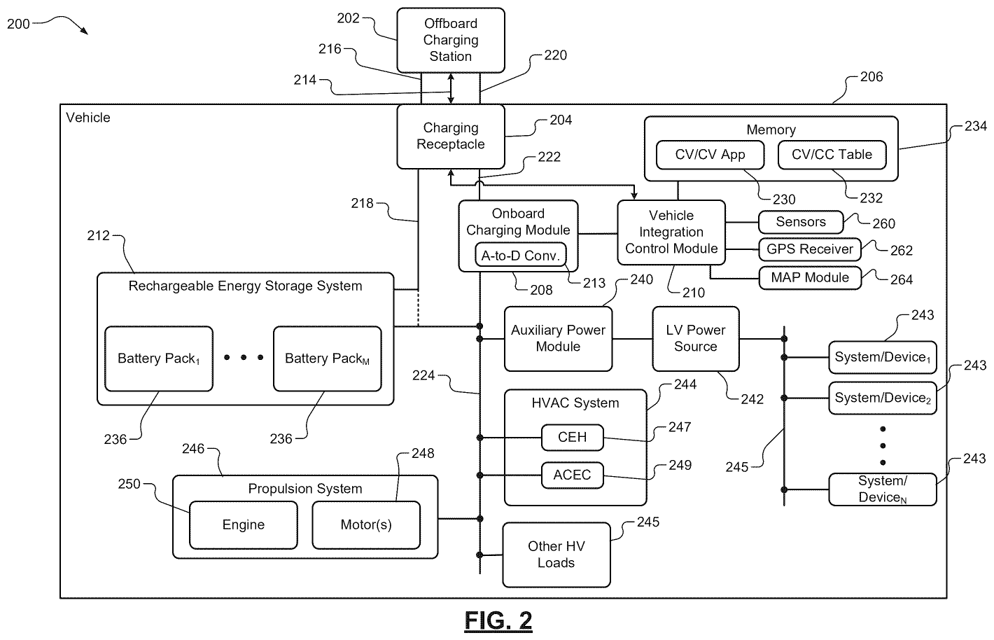

FIG. 2 depicts an implementation of a vehicle charging system 200 that includes an offboard charging station 202 (e.g., external charging system 120), a charging receptacle 204 (e.g., charging port 112) of a vehicle 206 (e.g., vehicle 150), an onboard charging module (OBCM) 208, a vehicle integration control module (VICM) 210 and a RESS 212 (e.g., energy source 102). The OBCM 208 includes an AD-to-DC converter 213 that converts HV AC to HV DC. The OBCM 208 controls an amount of current and power on the HV DC bus 224, a portion of which makes it to the RESS 212 during charging of the RESS 212. The OBCM 208 receives a voltage from the offboard charging station 202 and reports the voltage to the VICM 210, and in some implementations, the OBCM 208 may regulate the voltage on the HV DC bus 224.

The VICM 210 communicates with the offboard charging station 202 via a communication line 214 and controls charging of the RESS 212. In this regard, when the charging station 202 is realized as a DC fast charger, the VICM 210 controls charging of the RESS 212 directly via a first HV DC line 216 and a second HV DC line 218. In some scenarios or implementations, the HV DC line 218 may be connected to a HV DC bus 224. On the other hand, when the charging station 202 provides an AC charging current, the VICM 210 controls charging of the RESS 212 indirectly via a HV AC line 220, the OBCM 208, a line 222 between the charging receptacle 204 and the OBCM 208, and the HV DC bus 224. In this regard, the offboard charging station 202 may be a L1, L2 or L3 type charging station. The communication between the VICM 210 and the charging station 202 may include information pertaining to the charging capabilities of the offboard charging station 202 and may include instructions from the VICM 210 for setting terminal clamp voltages (CVs), cutoff current (CCs) and/or power outputs of the offboard charging station 202.

As illustrated, the RESS 212 may include one or more battery packs 236, which may be connected in series and/or parallel. The vehicle 206 further includes an auxiliary power module (APM) 240, a heating ventilation and air-conditioning (HVAC) system 244, a propulsion system 246, and/or other HV power sources. The APM 240 may convert the HV DC on the HV DC bus 224 to a LV DC and provide the LV DC to a LV power source 242 (e.g., a 12 V battery, a multiple output dynamically adjustable capacity system (MODACS), a 48 V power source, etc.). The LV power source 242 may have one or more positive terminals at one or more positive voltage potentials (e.g., 12 V and 48 V). The LV power source 242 supplies power to LV systems and/or devices 243, such as lighting systems, infotainment systems, navigation systems, object detection and/or collision avoidance systems, seat heaters and/or motors, window motors, door locks, etc. Although a single LV DC bus 245 is shown, more than one LV DC bus may be included. The HVAC system 244 may include a coolant electric heater (CEH) 247 and an air conditioning electric compressor (ACEC) 249. The propulsion system 246 may include one or more motors 248 and may include an internal combustion engine 250, which are used to drive one or more axles and corresponding wheels of the vehicle 206.

In various implementations, the VICM 210 determines commands for regulating the charging current and/or power output of the offboard charging station 202 (e.g., CV and CC pairs) based on communication with the offboard charging station 202 and information collected from sensors 260. The sensors 260 may include voltage sensors, current sensors, temperature sensors, etc. The current and voltage sensors may detect current and/or voltages of loads (e.g., loads 243, 247, 249, etc.), HV DC bus 224, LV DC bus 245, etc. The current and voltage sensors may detect current supplied to the RESS 212 and/or voltages of the RESS 212. The current and voltage sensors may detect current drawn from the offboard charging station 202 and/or voltage provided by the offboard charging station 202.

The illustrated vehicle 206 further includes a global positioning system (GPS) receiver 262 and a MAP module 264. The GPS receiver 262 may provide vehicle location information. The MAP module 264 may provide map information and/or charging station information, such as: charging station type information for the location of the offboard charging station 202; whether the charging station is a public charging station; and/or whether the charging station has a time-based cost for charging. The map information may also or alternatively indicate whether the vehicle 206 and/or offboard charging station 202 is in a parking structure. The VICM 210 may determine the type of the offboard charging station 202 based on this information. As an example, if the offboard charging station is located in a parking structure, then the offboard charging station may be determined to be a public charging station with a time-based cost for charging. Alternatively, the VICM 210 may determine through communication with the offboard charging station and/or with another network device the type and/or characteristics of the offboard charging station 202 including whether the offboard charging station 202 is a public or private charging station and/or whether the offboard charging station 202 has a time-based cost for charging.

Referring to FIGS. 1-2, in one or more exemplary implementations, the vehicle control system 108 includes the VICM 210, and the VICM 210 is the component of the vehicle control system 108 that is configurable to implement, execute or otherwise support a charging management service 230 based on calibration and/or configuration data 232 maintained in memory 234, which generally represents any sort of non-transitory computer-readable device or storage media capable of storing programming instructions for execution by the VICM 210 to provide the charging management service 230. That said, it should be appreciated that the subject matter described herein is not limited to the implementation with the vehicle charging system 200, the VICM 210, or any other particular module or controller associated with the vehicle electrical system 100.

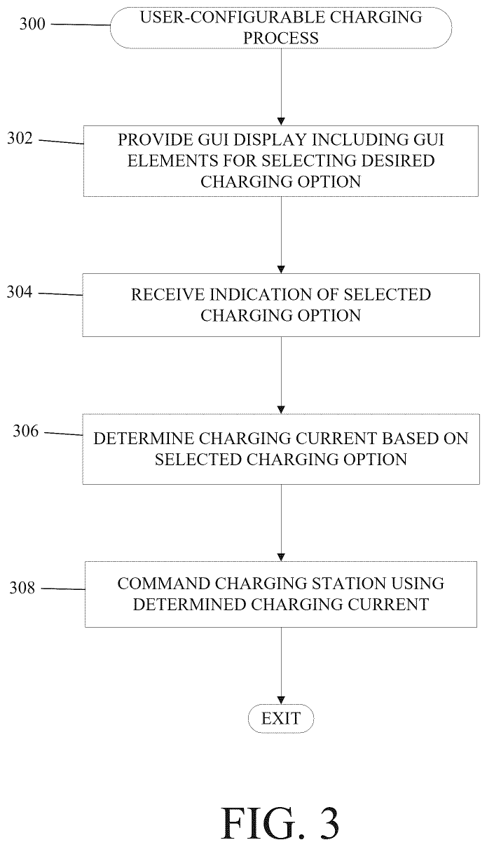

FIG. 3 depicts an exemplary user-configurable charging process 300 suitable for implementation by charging management service associated with a control module of a vehicle capable of communicating with an external charging station. For illustrative purposes, the following description may refer to elements mentioned above in connection with FIGS. 1-2. While portions of the user-configurable charging process 300 may be performed by different elements of a vehicle system, for purposes of explanation, the subject matter may be primarily described herein in the context of user-configurable charging process 300 being primarily performed by a charging management service implemented at a controller or other control module associated with a control system 108 of a vehicle 150, such as the VICM 210.

The user-configurable charging process 300 initializes or otherwise begins at 302 by generating or otherwise providing a GUI display including one or more GUI elements manipulable by a user to select a desired charging option for the vehicle. For example, in response to detecting a charging event (e.g., detecting the charging port 112 or charging receptacle 204 is connected to an external charging system 120 or other offboard charging station 202, detecting the transmission being placed in park, etc.), the control system 108 may automatically generate or otherwise provide a charging mode selection GUI display on a display device or other user interface device 110 that includes one or more buttons, drop-down menus, radio buttons, checkboxes, text boxes and/or the like that are manipulable by a driver or other user of the vehicle 150 to provide information indicative of a desired charging mode for the vehicle. In implementations where the user interface device 110 is realized as an electronic device associated with a vehicle owner or other user associated with the vehicle 150 that is separate and distinct from the vehicle 150, the control system 108 may automatically transmit a display request for the charging mode selection GUI display to the user interface device 110 over a communications network that is configurable to cause the user interface device 110 to display the charging mode selection GUI display.

In some implementations, the charging mode selection GUI display may include a first GUI button associated with a rapid charging mode configurable to request a maximum charging current from the external charging station and a second GUI button associated with a time optimized charging mode that is configurable to request a temperature control charging current that is configured to maximize energy delivery to the energy source 102 without exceeding temperature limits or other thresholds or constraints that would otherwise diminish the charging performance for the vehicle 150. For example, in practice, requesting the maximum charging current over a duration of time results in an increase in the temperature of the energy source 102 or RESS 212 that requires temperature derating and corresponding reduction in the charging current to protect the energy source 102 or RESS 212 from exceeding a maximum temperature derating threshold for maintaining durability and longevity, thereby reducing the cumulative amount of energy delivered to the energy source 102 or RESS 212 over a longer duration of time. In contrast, the temperature control charging current is configured to maintain the temperature of the energy source 102 or RESS 212 below maximum temperature derating threshold, thereby allowing maintaining a higher rate of energy delivery over a longer duration of time.

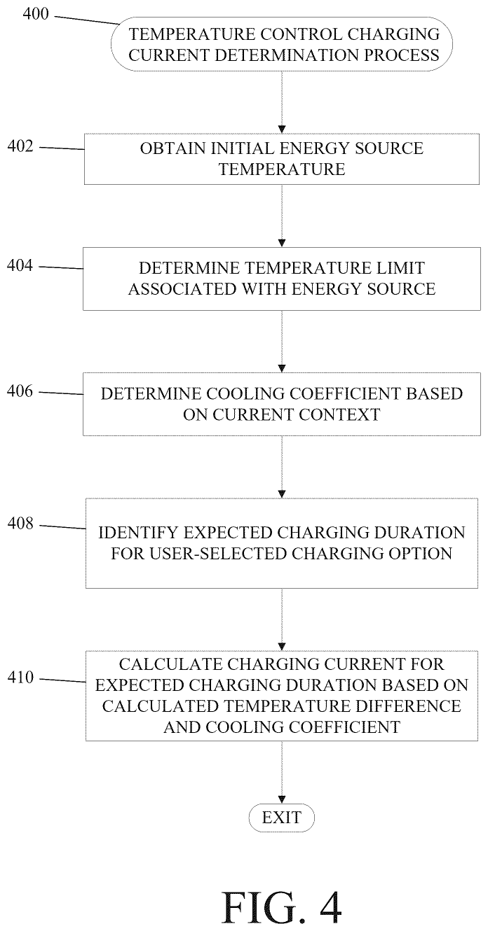

The user-configurable charging process 300 receives or otherwise obtains information indicative of the charging option selected by the user at 304 and then calculates or otherwise determines a charging current to be requested based on the user-selected charging option at 306. In exemplary implementations, the charging management service identifies the particular charging mode selected by the user in response to the user selecting or otherwise manipulating the button or other selectable GUI element associated with the respective charging mode. In this regard, when the user selects the button or other GUI element associated with the rapid charging mode, the charging management service determines the charging current to be requested is the maximum charging current limit associated with the energy source 102 or RESS 212. On the other hand, when the user selects the button or other GUI element associated with the time optimized charging mode, the charging management service calculates a temperature control charging current to be requested based on the expected charging duration for the time optimized charging mode, as described in greater detail below in the context of FIG. 4.

In some implementations, the charging mode selection GUI display may include one or more GUI elements associated with the time optimized charging mode that allow the user to input or otherwise define an anticipated or expected amount of time for which the user expects the vehicle 150 to be maintained connected to the external charging system 120 or charging station 202. That said, in other implementations, the time optimized charging mode may be configured for a default charging duration, such as, for example, an average or nominal amount of time required to raise the state of charge from a first lower state of charge (e.g., 10% or 20% state of charge) to a second upper state of charge (e.g., 80% state of charge).

After determining the charging current to be requested for the user-selected charging option, the user-configurable charging process 300 continues by requesting the determined charging current from the external charging system at 308. In this regard, the VICM 210 or other control module associated with the control system 108 that is implementing the charging management service may transmit or otherwise provide a command, instruction or other request to the charging controller 122 (e.g., via the charging port 112 and/or charging receptacle 204) that identifies the desired maximum charging current requested by the vehicle 150. The charging controller 122 associated with the external charging system 120 or other offboard charging station 202 is configurable to operate the external charging system 120 to deliver a charging current at the charging port 112 that is less than or equal to the maximum charging current requested by the vehicle 150. In this manner, when the time optimized charging mode is selected by the user, the charging management service communicates with the charging controller 122 to maintain the charging current less than or equal to the temperature control charging current that is configured to increase the total amount of energy to be provided to the energy source 102 over the expected charging duration of time relative to the maximum charging current handling capabilities of the energy source 102 by reducing the likelihood of temperature derating during the expected charging duration of time.

In one or more implementations, the charging management service is configurable to dynamically adjust the requested charging current in real-time throughout the duration of the charging event based on current temperature associated with the energy source 102 and potentially other contextual factors. For example, in one or more implementations, the charging management service is configured to determine the charging current to request as the minimum charging current selected from among a group of charging current limits including the user-configured charging current associated with the selected charging option (e.g., the current determined at 306), a lithium plating current limit, a fault prevention derating current limit, and/or the like. In this regard, during the charging event, as the temperature of the energy source 102 increases and/or other contextual factors associated with the vehicle 150 change (e.g., HVAC status and the like), one or more of the current limits may decrease to a value that is less than the user-configured charging current, resulting in the charging management service requesting a charging current that is less than the desired charging current associated with the selected charging option. In this regard, by virtue of the subject matter described herein, when the time optimized charging mode is selected, the charging management service provides a temperature control charging current that regulates the temperature of the energy source 102 to prolong the duration of time during which the lithium plating current limit and other derating current limits are greater than the value of the temperature control charging current, thereby maintaining the desired user-selected charging current to increase the total amount of energy delivered to the energy source 102 over the duration of the charging event. In contrast, when the rapid charging mode is selected, requesting the maximum charging current may increase the energy source 102 resulting in one or more of the lithium plating current limit and other derating current limits falling below the maximum charging current, which would otherwise reduce the amount of energy delivered to the energy source 102 over the duration of the charging event.

Accordingly, the user-configurable charging process 300 allows the user to control the manner in which the control system 108 interacts with the charging system 120 to charge the energy source 102 to better align with the user's charging objectives and the user's desired or expected duration of charging. In this regard, if the user intends to only charge the vehicle 150 for a brief period time, the user may select or otherwise indicate a desire to utilize a rapid charging mode to maximize the initial charging current provided to the energy source 102 to provide a greater rate of energy transfer to the energy source 102 over an initial period of charging. For example, a user charging a vehicle 150 at a charging system 120 realized as a DC Fast Charger at a commercial location (e.g., a store, a market, or other retail location) or governmental location (e.g., a library, a school, a park, and/or the like) where the user anticipates the charging duration to be relatively brief may select the rapid charging mode to maximize the charging rate over that brief charging duration. On the other hand, if the user intends to charge the vehicle 150 for a more extended period time (e.g., at a rest area, a restaurant, a truck stop, and/or the like), the user may select or otherwise indicate a desire to utilize a time optimized charging mode to automatically configure or adjust the initial charging current provided to the energy source 102 to maximize the amount of energy transferred to the energy source 102 over the expected duration of the charging event by maintaining the temperature of the energy source 102 below thermal derating thresholds and other thresholds that could otherwise limit charging capability.

FIG. 4 depicts an exemplary temperature control charging current determination process 400 suitable for implementation by charging management service in connection with the user-configurable charging process 300 at 306 to determine a temperature control charging current to be requested when a time optimized charging mode is selected by a user. For illustrative purposes, the following description may refer to elements mentioned above in connection with FIGS. 1-2. While portions of the temperature control charging current determination process 400 may be performed by different elements of a vehicle system, for purposes of explanation, the subject matter may be primarily described herein in the context of temperature control charging current determination process 400 being primarily performed by the charging management service implemented at a controller or other control module associated with a control system 108 of a vehicle 150, such as the VICM 210.

The illustrated implementation of the temperature control charging current determination process 400 initializes at 402 by receiving or otherwise obtaining an initial temperature of the energy source prior to or at the start of the charging event before requesting charging current from the external charging system. In this regard, in response to detecting a charging event (e.g., detecting the transmission being placed in park, detecting connection to an external charging system 120 or other offboard charging station 202, etc.), the charging management service receives or otherwise obtains a current measurement of the energy source temperature (e.g., from a temperature sensor 260).

The temperature control charging current determination process 400 also identifies or otherwise determines a temperature limit associated with the energy source at 404 based on one or more factors characterizing the current operating environment and/or context. In this regard, the temperature limit represents the thermal capacity or capability of the energy source, where an energy source temperature exceeding the temperature limit is likely to result in one or more other derating current limits falling below the temperature control charging current and reducing the charging rate at 308 of the user-configurable charging process 300. In some implementations, the charging management service may dynamically determine the temperature limit in real-time based on the current status of one or more vehicle systems, such as, for example, the current state of the HVAC system 244 (e.g., whether the CEH 247 and/or ACEC 249 is in operation), the current state of other LV systems and/or devices 243, the current state of the APM 240, the current state of the LV power source 242, the current voltages and/or currents associated with one or more loads 243, 247, 249, HV DC bus 224 and/or the LV DC bus 245, and/or the current state of the RESS 212 (e.g., the current voltage level, the current state of charge, whether one or more fault conditions exists, etc.). In some implementations, the charging management service calculates the energy source temperature limit value in real-time based on the current or instantaneous values or states for the respective environmental and/or contextual factors that influence the thermal capacity of the energy source. In other implementations, a previously calibrated energy source temperature limit value may be identified using a lookup table for a given input set or combination of values for the respective environmental and/or contextual factors.

In a similar manner, the temperature control charging current determination process 400 also identifies or otherwise determines a vehicle cooling capability associated with the energy source at 406 based on one or more factors characterizing the current operating environment and/or context. In this regard, the vehicle cooling capability represents the ability of the vehicle or ambient environment to mitigate an increase to the temperature of the energy source during a charging event. In some implementations, the charging management service may dynamically determine the temperature limit in real-time based on the current measurement of the ambient temperature (e.g., from a temperature sensor 260) and the status of one or more vehicle systems or other vehicle factors (e.g., the current state of the HVAC system 244, the current state of other LV systems and/or devices 243, and/or the like). Depending on the implementation, the charging management service calculates the vehicle cooling capability value in real-time based on the current or instantaneous ambient temperature measurement value and other values or states for the respective environmental and/or contextual factors that influence the cooling efficiency of the current operating environment, while in other implementations, a previously calibrated vehicle cooling capability value may be identified using a lookup table for a given input set or combination of values for the respective environmental and/or contextual factors.

At 408, the temperature control charging current determination process 400 identifies or otherwise determines the expected duration of the charging event corresponding to the user-selected charging option and then calculates or otherwise determines a value for the temperature control charging current at 410 based on the expected charging duration, the current vehicle cooling capability value, and the difference between the current temperature limit for the energy source and the initial temperature of the energy source. For example, in one exemplary implementation, the charging management service calculates the temperature control charging current (Iₜ) in accordance with the equation

$${I}_{t} = \sqrt{( \frac{1}{R} ( \frac{m * c * Δ T}{Δ t} + {q}_{c} ) )} ,$$

where Δt represents the expected charging duration of time, q_{c} represents a cooling capability of the vehicle (e.g., how much thermal power the vehicle can dissipate or remove from the energy source), ΔT represents the difference between current temperature limit for the energy source and the initial temperature of the energy source, and m, c, and R are values representing the heating characteristics of the energy source including mass of the energy source, the specific heat of the energy source, and the resistance of the energy source, respectively. In this regard, the factors characterizing the heating characteristics of the energy source (m, c, and R) may be fixed previously calibrated values or estimated or otherwise determined in real-time from battery state estimation, the details of which are not germane to this disclosure.

Referring to FIGS. 3-4, in implementations where the charging mode selection GUI display includes GUI elements manipulable to allow the user to define the expected charging duration, the value for Δt is equal to the value for the expected charging duration that was input or otherwise selected by the user. On the other hand, in the absence of a user input expected charging duration of time, the value for Δt may be set to a default charging duration value that represents the average or nominal amount of time required to raise the state of charge from a lower state of charge (e.g., 20% state of charge) to an upper state of charge (e.g., 80% state of charge). In some implementations, the expected charging duration of time may be dynamically calculated in real-time at the start of the charging event based on a relationship between the initial state of charge of the energy source 102 at the start of the charging event and a targeted state of charge value (e.g., 80% state of charge). In yet other implementations, the charging mode selection GUI display may include GUI elements manipulable to allow the user to define the targeted state of charge for the energy source 102, which, in turn, may be utilized by the charging management service to calculate the expected charging duration of time based on a relationship between the initial state of charge of the energy source 102 at the start of the charging event and the user-configured targeted state of charge value. In such implementations, the charging management service may be configured to dynamically update the charging mode selection GUI display to identify the expected charging duration of time or otherwise provide a user notification that indicates the expected charging duration of time for reaching the user-configured targeted state of charge value while maintaining the temperature of the energy source 102 below any derating limits or other thresholds that could reduce the rate of energy transfer to the energy source 102. Additionally, it should be noted that in addition to the expected charging duration of time being input by a user or determined based on a target state of charge, in various implementations, the expected charging duration of time may be provided by a software process or service associated with trip planning software, navigation software, or some other infotainment software.

When the time optimized charging mode is selected and the calculated value for the temperature control charging current (Iₜ) is less than other applicable derating current limits, at 308, the VICM 210 or other control module associated with the control system 108 transmits a request for the calculated temperature control charging current value to the charging controller 122 associated with the external charging system 120 or other offboard charging station 202, which, in turn, results in the external charging system 120 to delivering a charging current at the charging port 112 that is less than or equal to the requested temperature control charging current value. For example, the temperature control charging current value calculated at 410 may be realized as a temperature control DC charging current to be requested from a DC Fast Charger rather than requesting a maximum DC charging current associated with the energy source 102 and/or the external charging system 120. As a result, the temperature of the energy source 102 may be maintained below the temperature limit determined at 404 throughout the expected charging duration of the charging event, Δt. Thereafter, if the duration of the charging event exceeds the expected charging duration, one or more derating current limits may fall below the temperature control charging current as the state of charge of the energy source 102 or other environmental and/or contextual factors change during the charging event, which, in turn, may result in the charging management service transmitting a request for a charging current that is less than the calculated temperature control charging current value at 308. In this manner, the temperature control charging current determination process 400 in concert with the user-configurable charging process 300 may increase the total energy delivered to the energy source 102 over the duration of the charging event relative to rapid charging or other modes where a greater charging current is initially requested that results in subsequent derating of the charging current prior to the expected charging duration elapsing, which would reduce the total energy delivered to the energy source 102.

For sake of brevity, conventional techniques related to vehicle electrical systems, electric vehicles, rechargeable energy storage systems (RESSs) or other high voltage rechargeable battery packs, power converters, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an implementation of the subject matter.

As used herein, the word “exemplary” means “serving as an example, instance, or illustration.” Thus, any implementation described herein as “exemplary” is not necessarily to be construed as preferred or advantageous over other implementations. All of the implementations described herein are exemplary implementations provided to enable persons skilled in the art to make or use the invention and not to limit the scope of the invention which is defined by the claims.

Those of skill in the art will appreciate that the various illustrative logical blocks, modules, circuits, and algorithm steps described in connection with the implementations disclosed herein may be implemented as electronic hardware, computer software, or combinations of both. Some of the implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is logically coherent.

Furthermore, the foregoing description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. For example, two elements may be coupled to each other physically, electronically, logically, or in any other manner, through one or more additional elements. Thus, although the drawings may depict one exemplary arrangement of elements directly connected to one another, additional intervening elements, devices, features, or components may be present in an implementation of the depicted subject matter. In addition, certain terminology may also be used herein for the purpose of reference only, and thus are not intended to be limiting.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A method of charging an energy source in a vehicle coupled to an external charging system, the method comprising:
receiving, by a control module associated with the vehicle, a first user input indicative of a selected charging mode from among a plurality of charging modes;
determining, by the control module, an expected duration of time for a charging event associated with the selected charging mode;
receiving, by the control module, a current temperature indicator from a temperature sensor associated with the vehicle;
determining, by the control module, a current temperature associated with the energy source based on the current temperature indicator;
determining, by the control module, a temperature control charging current for the charging event based at least in part on the current temperature and the expected duration of time for the charging event; and
transmitting, by the control module, a current request for the temperature control charging current to the external charging system.

2. The method of claim 1, wherein receiving the first user input comprises:
transmitting, by the control module, a display request for a charging mode selection graphical user interface (GUI) to be displayed on a user interface device associated with the vehicle, wherein the charging mode selection GUI includes a plurality of GUI elements for receiving the first user input indicative of the selected charging mode; and
determining, by the control module, the selected charging mode in response to manipulation of a respective GUI element of the plurality of GUI elements associated with the selected charging mode.

3. The method of claim 2, wherein:
the charging mode selection GUI includes a first GUI element for receiving a second user input indicative of a user's expectation of a duration of time for the charging event; and
determining the expected duration of time for the charging event is further based on the second user input.

4. The method of claim 2, wherein providing the charging mode selection GUI comprises automatically providing the charging mode selection GUI in response to detecting a connection between a charging port of the vehicle and the external charging system.

5. The method of claim 2, further comprising receiving, by the control module, a vehicle park indicator indicating that a transmission of the vehicle has been placed into park; and wherein the control module transmits the display request in response to receiving the vehicle park indicator.

6. The method of claim 1, wherein the expected duration of time corresponds to charging the energy source above a targeted state of charge.

7. The method of claim 6, further comprising determining an initial state of charge of the energy source prior to the charging event, wherein determining the expected duration of time for charging the energy source above the targeted state of charge comprises calculating the expected duration of time based on a relationship between the initial state of charge and the targeted state of charge.

8. The method of claim 1, further comprising determining a temperature limit associated with the energy source based at least in part on a current operating context, wherein determining the temperature control charging current comprises determining the temperature control charging current for the charging event based at least in part on a difference between the temperature limit and the current temperature.

9. The method of claim 8, further comprising determining a cooling capability of the vehicle based at least in part on the current operating context, wherein determining the temperature control charging current comprises determining the temperature control charging current for the charging event based at least in part on the cooling capability.

10. The method of claim 9, wherein determining the temperature control charging current comprises calculating a value for the temperature control charging current in accordance with the equation
$${I}_{t} = \sqrt{( \frac{1}{R} ( \frac{m * c * Δ T}{Δ t} + {q}_{c} ) )} ,$$
wherein:
Iₜ represents the temperature control charging current;
Δt represents the expected duration of time for the charging event;
q_{c} represents the cooling capability of the vehicle;
ΔT represents the difference between the temperature limit and the current temperature;
m represents a mass of the energy source;
c represents a specific heat of the energy source; and
R represents a resistance of the energy source.

11. The method of claim 1, wherein determining the temperature control charging current comprises calculating a value for the temperature control charging current in accordance with the equation
$${I}_{t} = \sqrt{( \frac{1}{R} ( \frac{m * c * Δ T}{Δ t} + {q}_{c} ) )} ,$$
wherein:
Iₜ represents the temperature control charging current;
Δt represents the expected duration of time for the charging event;
q_{c} represents a cooling capability of the vehicle;
ΔT represents a difference between a temperature limit and the current temperature;
m represents a mass of the energy source;
c represents a specific heat of the energy source; and
R represents a resistance of the energy source.

12. A non-transitory computer-readable medium comprising executable instructions that, when executed by a processor, cause the processor to provide a charging management service configurable to:
receive user input indicative of a selected charging mode from among a plurality of charging modes for an energy source of a vehicle;
determine an expected duration of time for a charging event associated with the selected charging mode;
receive a current temperature indicator from a temperature sensor associated with the vehicle;
determine a current temperature associated with the energy source based on the current temperature indicator;
determine a temperature control charging current for the charging event based at least in part on the current temperature and the expected duration of time for the charging event; and
transmit a current request for the temperature control charging current to an external charging system.

13. The non-transitory computer-readable medium of claim 12, wherein the charging management service is configurable to:
provide a charging mode selection graphical user interface (GUI) on a user interface device associated with the vehicle, wherein the charging mode selection GUI includes a plurality of GUI elements for receiving the user input indicative of the selected charging mode; and
identify the selected charging mode in response to manipulation of a respective GUI element of the plurality of GUI elements associated with the selected charging mode.

14. The non-transitory computer-readable medium of claim 13, wherein:
the charging mode selection GUI includes a first GUI element for receiving a second user input indicative of the expected duration of time; and
the charging management service is configurable to identify the expected duration of time based on the second user input.

15. The non-transitory computer-readable medium of claim 12, wherein the charging management service is configurable to identify the expected duration of time based at least in part on a targeted state of charge.

16. The non-transitory computer-readable medium of claim 12, wherein the charging management service is configurable to determine a temperature limit associated with the energy source based at least in part on a current operating context, wherein determining the temperature control charging current comprises determining the temperature control charging current for the charging event based at least in part on a difference between the temperature limit and the current temperature.

17. The non-transitory computer-readable medium of claim 16, wherein the charging management service is configurable to calculate a value for the temperature control charging current in accordance with the equation
$${I}_{t} = \sqrt{( \frac{1}{R} ( \frac{m * c * Δ T}{Δ t} + {q}_{c} ) )} ,$$
wherein:
Iₜ represents the temperature control charging current;
Δt represents the expected duration of time for the charging event;
q_{c} represents a cooling capability of the vehicle;
ΔT represents the difference between the temperature limit and the current temperature;
m represents a mass of the energy source;
c represents a specific heat of the energy source; and
R represents a resistance of the energy source.

18. A vehicle system including:
an electric motor;
an energy source;
a temperature sensor to provide an indication of a current temperature of the energy source;
a power conversion module coupled between the energy source and the electric motor;
a charging port coupled to the energy source;
a user interface device; and
a control module coupled to the energy source, the charging port and the user interface device to provide a charging management service configurable to:
provide a charging mode selection graphical user interface (GUI) on the user interface device, wherein the charging mode selection GUI includes a plurality of GUI elements for receiving a user input indicative of a selected charging mode;
determine an expected duration of time for a charging event associated with the selected charging mode;
determine a temperature control charging current for the charging event based at least in part on the expected duration of time for the charging event and the indication of the current temperature of the energy source; and
transmit a current request for the temperature control charging current to an external charging system coupled to the charging port.

19. The vehicle system of claim 18, wherein:
the expected duration of time is influenced by a targeted state of charge for the energy source; and
the energy source comprises at least one of a rechargeable energy storage system (RESS) and a rechargeable high voltage battery pack.

20. The vehicle system of claim 18, wherein the charging management service is configurable to automatically provide the charging mode selection GUI on the user interface device in response to detecting a connection between the charging port and the external charging system.
